(19) United States
(12) Patent Application Publication
(10) Pub. No.: US 2012/0240203 A1
(43) Pub. Date: Sep. 20, 2012

(54) METHOD AND APPARATUS FOR ENHANCING ONLINE TRANSACTION SECURITY VIA SECONDARY CONFIRMATION

(76) Inventor: Ashley S. Kling, Sunnyvale, CA (US)

(21) Appl. No.: 13/048,949

(22) Filed: Mar. 16, 2011

(51) Int. Cl. H04L 9/32

(52) U.S. Cl. 726/5

(57) ABSTRACT

The need for secure online transaction on inherently insecure platforms such as PCs and mobile devices is increasing with the widespread adoption of e-commerce and online banking. Providing enhanced security on such platforms is challenging as factors of cost and user convenience are significant barrier to adoption rates. The proposed invention does not require special hardware, operating systems or communication links installed on the client devices. Instead, it makes use of the fact that a large number of consumers already have access to multiple independently operating devices such as PCs and cellular phones. Providing secondary confirmation for secure transactions using a plurality of such devices addresses both the cost and ease-of-use factors. In particular, a secure transaction that is originated on one type of consumer device such as a PC is conducted to require a secondary transaction on a different device such as a mobile phone. This way an attacker faces the much harder problem of synchronously compromising two very different systems to gain control of a particular secure transaction.

### FIELD OF THE INVENTION

This invention relates generally to the field of online transaction security.

### BACKGROUND

Conventional methods for providing online transaction security typically require authentication typically by using passwords and encrypted communication channels. Password protection can be further enhanced by requiring different passwords for different types of operations or so called one-time passwords that are only valid for a single transaction. In addition to passwords, stronger authentication methods include biometric scanning devices such as retina or finger print scanners and security dongles that have to be physically attached to a terminal.

The methods described above can provide adequate security for online transactions provided that the terminal device used for communication or some aspects of the communication channel to the remote secure server are not compromised. Such hardware security could be achieved by using special purpose hardware and software for the terminal and private communication lines. While this can be an appropriate solution for secure transaction between banks, for example, it is cost prohibitive for consumer use. As consumer online transactions such as for electronic banking are becoming much more widespread so are the incidents of compromised accounts and associated losses. In particular, consumers are likely to use very insecure platforms such as PCs and mobile phones which are prone to malware attacks.

The purpose of the invention is to overcome the challenge of providing adequate security for online transactions on inherently insecure platforms.

### SUMMARY

The invention provides access to enhanced online transaction security without the need for costly special purpose hardware, hardened software such as operating systems or private communication channels. The user can continue to use everyday devices such as PCs or mobile phones for conducting secure online transactions. In one embodiment, no special software is required on the client devices at all, a regular Web browser is sufficient for this purpose.

In another embodiment, the user is provided with a custom application for a mobile device such as a cell phone. Such an application could be provided in the same manner as any other application for the mobile device, for example via an “app store”. No special operating system changes are required on the mobile device.

The invention makes use of the multi-factor authentication principle which states that multiple independent means of providing authentication factors are more secure than one. In one embodiment of the invention the user is required to approve a specific secure transaction on a mobile device in addition to the original transaction performed on a PC. Due to the fact that PCs and mobile devices typically use different Web browsers, operating systems and communication channels the overall security of this two-factor authentication is substantially higher than the original single factor authentication performed on a PC. In this case an attacker would have to compromise both the user's PC and mobile device at the same time with knowledge about this particular transaction to defeat the security. This scenario is much less likely than a single compromised PC.

### BRIEF DESCRIPTION OF THE DRAWINGS

FIG. 1 is a block diagram illustrating a system for performing online transactions and associated vulnerability zones.

FIG. 2 is a flow chart showing a regular password protected transaction.

FIG. 3 is a flow chart showing a compromised regular password protected transaction.

FIG. 4 is a flow chart showing a password protected transaction with secondary authentication according to one embodiment of the invention.

FIG. 5 is a flow chart showing a failed attempt to compromise a password protected transaction with secondary authentication according to one embodiment of the invention.

### DETAILED DESCRIPTION OF INVENTION

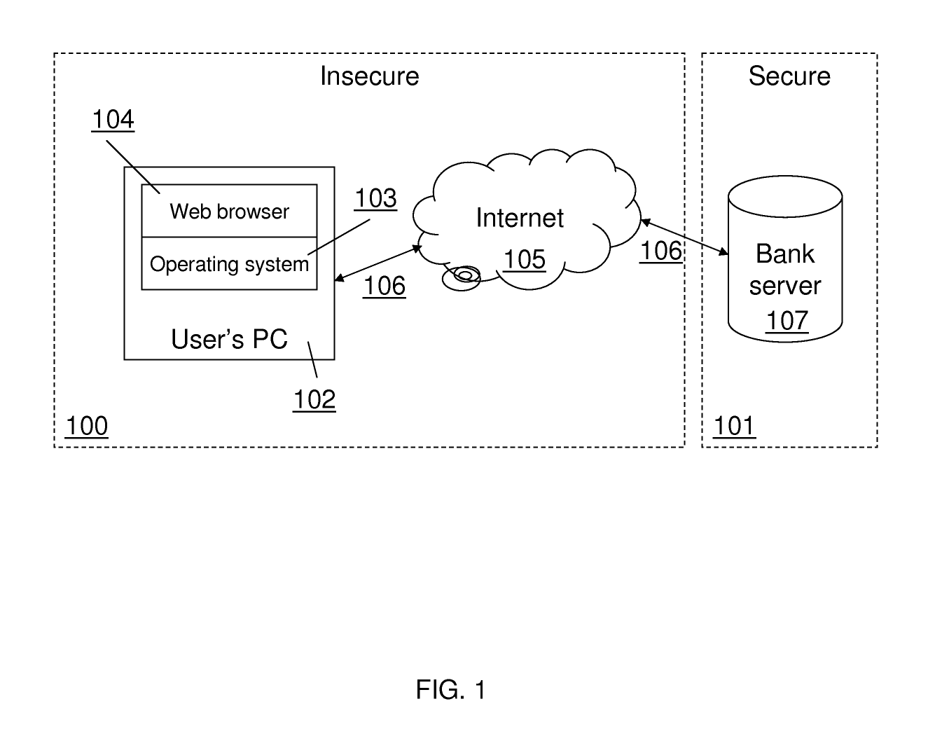

Embodiments of the invention can be hosted on various computing devices but for clarity reasons we will focus on PCs and cell phones in this description. FIG. 1 describes the threat model that is underlying the invention. Assume a user want to make a sure transaction from a local PC 102 to a remote server 107. In this model the assumption is that devices in area 100 are susceptible to malware attacks while devices in area 101 are secure. Particularly vulnerable to attacks are the user's operating system 104 and applications such as a Web browser 104. Furthermore, network links 106 and Internet infrastructure 105 may be compromised to some degree as well.

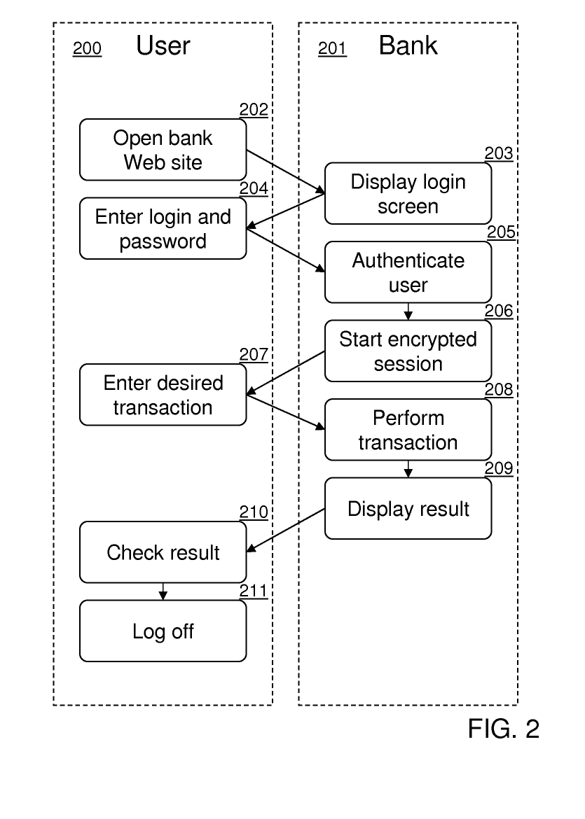

A flow chart of the user's transactions 200 with a remote server 201 are shown in FIG. 2. Typically, the user would open a Web site 202, in this example of a bank. After being prompted for a login and password 203, 204 a presumably secure transaction session is opened with the remote server 205, 206. In this session the user may enter an online banking transaction 207, for example to transfer a certain sum of money to another account. The server will perform this transaction 208 and generate a result page 209 which is then displayed to the user. The user has the opportunity to check the result 210 and then may log off.

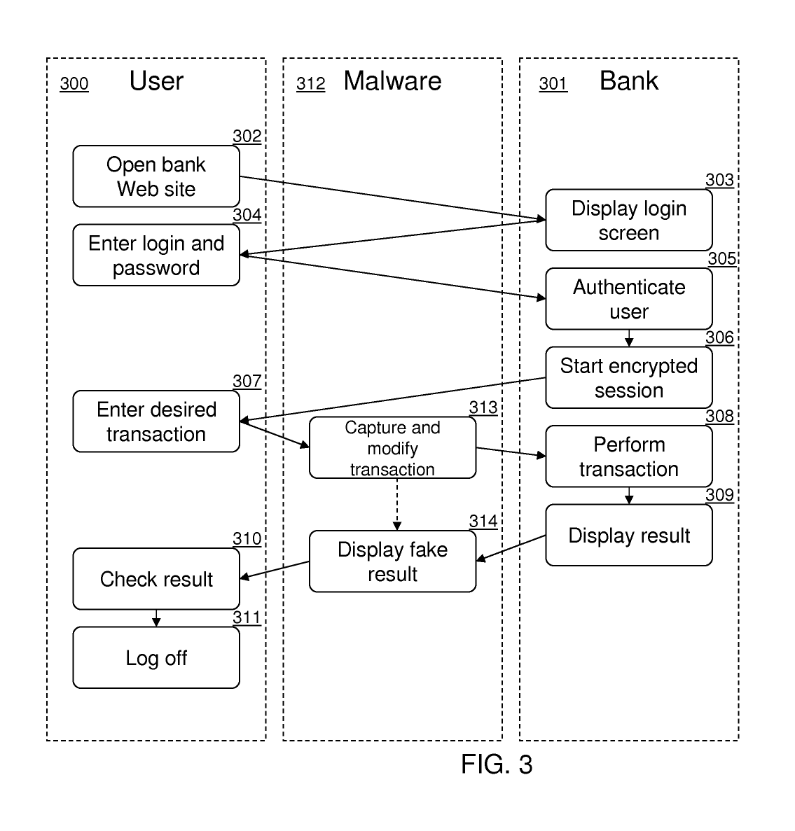

In FIG. 3. a similar flow chart is displayed, however, in this case the user's local PC is compromised by Malware 312. The initial logon process and start of transaction 302-307 happen exactly as in the previous case. However, after the user enters a transaction the malware on his computer's Web browser intercepts the request. This is possible despite the fact that a secure transaction with the server is established as the user enters his data in clear text into the Web browser's window. As the Web browser itself is compromised the user's information can be captured and modified before being encrypted for transmission over the Internet.

The malware proceeds to change the user's transaction 313, for example by increasing the amount of money transferred and the destination account number. The bank server, being unaware of the modification, will dutifully carry out the transaction 308 and send a result screen 309. Before the bank's Web page reaches the screen with the modified result the browser malware again intercepts the transmission between being decrypted and being displayed. Having captured the user's original intent the malware can now generate a fake screen 314 to display to the user 310 who will falsely believe that the original transaction has been faithfully processed.

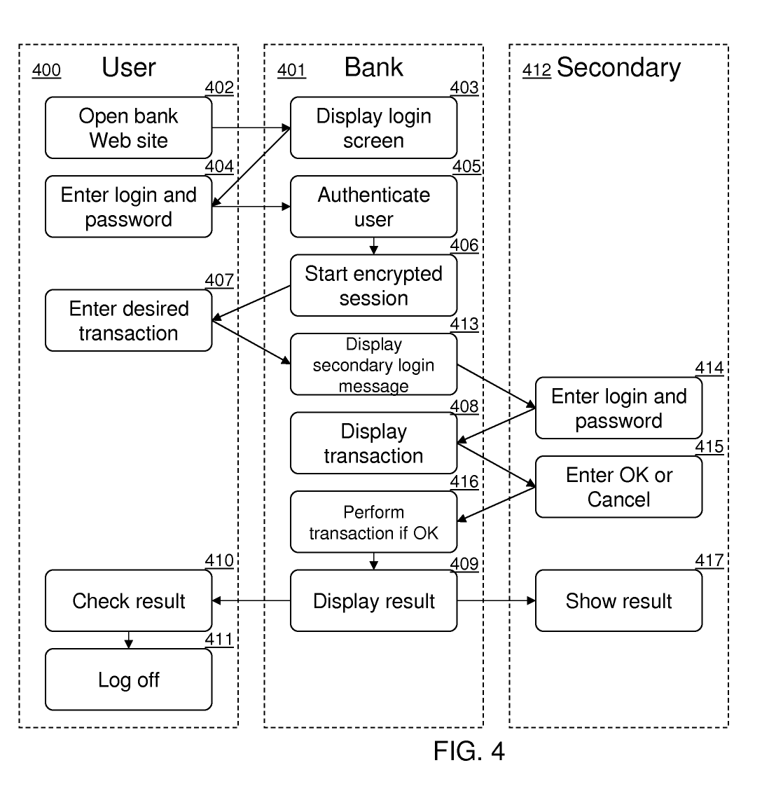

With this scary scenario in mind let us consider how an embodiment of the invention can defeat such an attack. In FIG. 4. a similar flow chart is shown as before, however, this time the bank server 401 employs secondary authentication 412. Steps 402-407 proceed just like the flow shown in FIG. 2. Upon receiving the user's transaction request the bank sever may decide, based on a set of rules to invoke a secondary authentication request 413. Such rules could take into account various factors such as the transaction amount and type, the user's security history, the type of Web browser used and the like. The secondary authentication request may be sent to a mobile device such as a cell phone that the user has previously registered with the bank server. Such a request can be sent by various means such as Internal “push” data or SMS. The mobile device may open up a Web browser or invoke a specialize mobile banking app upon receipt of the server notification

Typically the user would be prompted to log into the mobile device, ideally using a different password than on the PC. Subsequently, a secure session is established between the bank server and the mobile device and the transaction is displayed for confirmation 408. The user can chose to confirm or cancel this request 415 which will terminate the secondary session. If the user confirmed the transaction the server will process it 416 and generate a result page 409 which is displayed on the user's PC and mobile device 417. Otherwise a cancellation page will be generated as the result. The user can then check the final result 410 before ending the primary session 411.

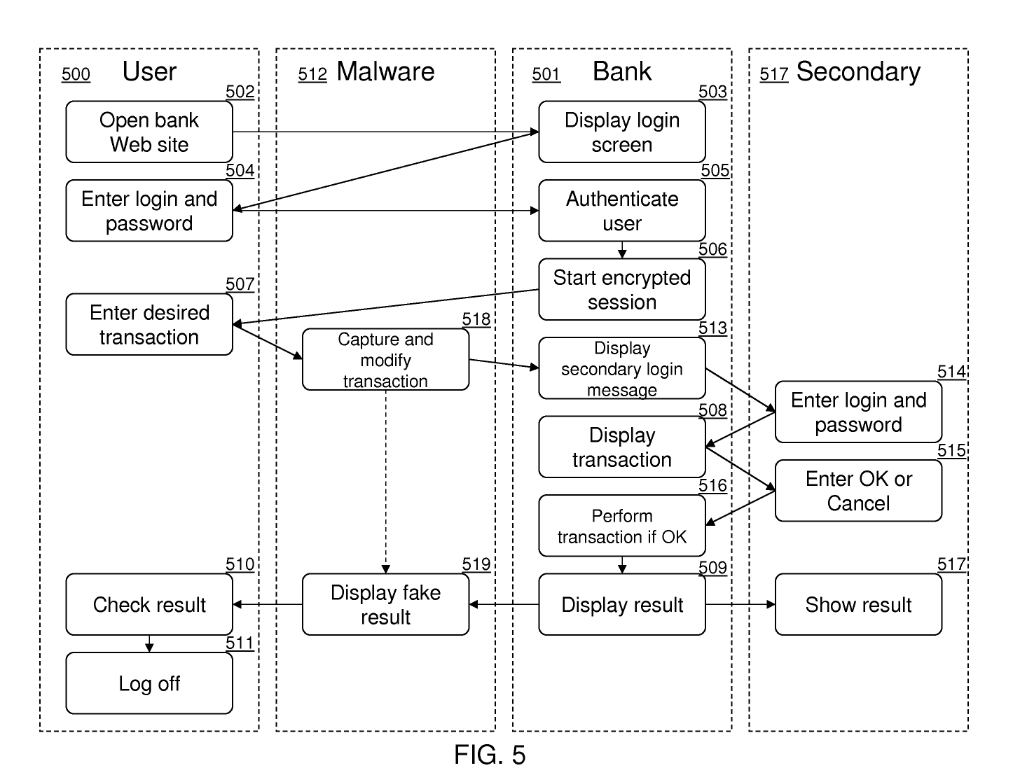

Now let's again consider a malware-compromised browser as depicted in the flow chart in FIG. 5. The initial login process 502-507 remains the same as previously described. In step 518 the malware again maliciously intercepts and modifies the transaction. The bank server generates a secondary confirmation request 513, 514 and shows the now modified transaction 508 to the user. Upon seeing the modified transaction the user will suspect foul play and cancel rather than confirm the transaction on the mobile device 515. Having received a negative acknowledgement the bank server will not perform the transaction 516 and generate an appropriate message to the user's primary 509 and secondary 517 displays. The malware may intercept this error message from the server and generate a fake result 519 which the user will see on the primary PC 510. However, having performed the cancellation on the mobile device the user can be assured that the modified transaction did not occur.

What is claimed is:

1. A secondary confirmation system comprising of at least one secure server and first and second user level computing devices.

2. The apparatus of claim 1, further comprising of the user's devices being a PC and a mobile device or two independent PCs or two mobile devices.

3. The apparatus of claim 2, wherein the user's first device is compromised by malware.

4. A method comprising:
a user initiating an online transaction to a secure server on a potentially compromised first device; and
the secure server generating a secondary confirmation request on the user's second device.

5. The method of claim 4 wherein the second device has been pre registered with the server by the user.

6. The method of claim 4 wherein the user has the ability to cancel the transaction request generated on the first device when prompted for confirmation by the second device.

7. The method of claim 6 wherein additional security against real time modifications by malware on the first device is provided.

8. The method of claim 4 wherein the secondary confirmation does not require a secure channel, e.g., via text messaging.

9. The method of claim 8 wherein a secure transaction may not be initiated on a secondary device.
